(19) United States
(12) Patent Application Publication
(10) Pub. No.: US 2015/0353297 A1
(43) Pub. Date: Dec. 10, 2015

(54) CONVEYOR FOR BOTTLES OR SIMILAR CONTAINERS, AND A CONTAINER-TREATMENT MACHINE

(71) Applicant: KHS GmbH, Dortmund (DE)

(72) Inventors: Andreas Fahldieck, Idar-Oberstein (DE); Michael Krell, Roxheim (DE)

(21) Appl. No.: 14/763,599

(22) PCT Filed: Feb. 11, 2014
(86) PCT No.: PCT/EP2014/000368

§ 371 Date: Jul. 27, 2015

(30) Foreign Application Priority Data
Feb. 19, 2013 (DE) 10 2013 101 645.6

(51) Int. Cl. B65G 47/86; B67C 7/00; B67C 3/24

(52) U.S. Cl. CPC B65G 47/847; B67C 3/242; B67C 7/0053

(57) ABSTRACT

A conveyor for conveying containers uses vertically-extending holder-sheets to form container pockets that support the containers. The holder-sheets shift radially in opposite directions to accommodate different container sizes.

### RELATED APPLICATIONS

This is the national stage under 35 USC 371 of international application PCT/EP2014/000368, filed on Feb. 11, 2014, which claims the benefit of the Feb. 19, 2013 priority date of German application DE 102013101645.6, the contents of which are herein incorporated by reference.

### FIELD OF INVENTION

The invention relates to container treatment, and in particular to a conveyor used in a container-treatment machine.

### BACKGROUND

It is known to convey bottles or similar containers with a transport element that rotates about a vertical machine axis. Known transport elements include a rotor that has container-treatment positions on a circumference thereof. These container-treatment positions suspend containers along an arcuate transport section.

It is also known for each such container-receiving position to have pairs of finger-like container-supports. The two container-supports of each pair hold a container between them. Each such pair thus defines a container holder.

To adapt the width of a container holder to different container diameters, the finger-like container-supports swivel in opposite directions about axes parallel to the machine axis. Preferably, the finger-like container-supports of all container-receiving positions swivel simultaneously using common adjustment rings.

One disadvantage of these known conveyors is that contact area with the container being supported does not extend very far in the vertical direction. Another disadvantage is that the finger-like container-supports require considerable space. This makes it difficult to fit very many such pairs on the periphery of the rotor.

In another known conveyor, each container-receiving position on a circumference of a rotor has clamping arms or fingers as well as a support element. The container lies with a circumferential region thereof at the support element. The support element moves radially relative to the machine axis.

Another known bottle conveyor has trough-like container holders on a circumference of a rotor. To form the container holders in which the bottle is held by part of its circumference, a belt is fed over guide pins that are provided on two bearing rings arranged on the same axis as the machine axis. To adapt the container holders to bottles of different diameters, one turns the two bearing rings around the machine axis.

Also known are conveyors in which contact points for the containers are made of holder sheets. However, these holder sheets do not form container pockets that reliably hold containers. Instead, they are offset relative to each other in an axial direction parallel to the machine axis and to the container axis.

### SUMMARY

The invention provides a conveyor and support elements for bottles or similar containers that, subject to a constraint of simplified structural design and high level of operational reliability, provide improved container contact and improved adaptation to different container diameters.

In the conveyor according to the invention, holder sheets that stand vertically upright with planes of their surfaces parallel to the machine axis form the container contact-and-support elements. These extend by a height that is greater by a multiple than the thickness of the material used for the holder sheets. The holder sheets, which are made, for example, of a metal, e.g. of corrosion-resistant steel, form container pockets. These pockets are made to have considerable vertical extent. In some embodiments, the pockets extend vertically for more than 50% of the height of the largest bottle for which the conveyor is designed. In other embodiments, the corresponding figure is 60%. This guarantees a contact-and-support region of considerable extent in the direction of the machine axis.

In a preferred embodiment, two holder sheets are provided at each container-receiving position. These holder sheets form a container pocket between them for at least partially holding a container. Swiveling the holder sheets about a swivel axis parallel to the machine axis provides a way to adapt the positions of the holder sheets relative to the machine axis.

In some embodiments, the swivel axis is the machine axis itself. In other embodiments, the swivel axis is radially offset relative to the axis of the container receiving position. In some of these embodiments, the swivel axis is offset such that it is closer to the machine axis than it is to the axis of the container receiving position.

Among the embodiments are those in which the conveyor is part of a transport section between units or machines of a container-treatment installation. Examples of container-treatment installations include installations for manufacturing containers by blow-molding, installations for filling containers, and installations for sealing filled containers.

In some embodiments, the conveyor is part of a container-treatment machine in which the container-receiving positions are container-treatment positions on a circulating transport element or rotor. Examples of such container-treatment positions include filling positions of a filling machine, and sealing positions of a sealing machine.

In one aspect, the invention features an apparatus for processing containers that has a conveyor for conveying these containers. The conveyor includes rotates about a vertical machine axis and has container-receiving positions formed on its circumference, rim, or periphery. Each such container-receiving position includes a container carrier, first and second container-support elements, and first and second holder-sheets. The container carrier holds a container with a container axis thereof held substantially coaxial to a container-receiving position axis of the container-receiving position. This container-receiving-position axis is oriented parallel to the machine axis. The first and second container-support elements and the first and second holder-sheets are disposed underneath the container carrier. The first and second holder-sheets form contact points for a lateral surface of a container. The first and second holder-sheets shift radially in opposite directions relative to the container axis. This radial shifting enables adaptation of the container-receiving position to different container diameters. The two holder-sheets are arranged with surfaces on vertical planes that are parallel to the machine axis and to the container-receiving-position axis and lie opposite each other along a circumferential direction of the rotor. Between them, the holder-sheets form a container pocket for a container suspended by the container carrier.

Embodiments include those in which the conveyor is configured to convey containers having different heights, of which one height is the greatest. Among these are those in which the first holder-sheet extends over at least 50% of the greatest height, and those in which it extends over at least 60% of the greatest height.

Other embodiments also include first and second adjustment elements or adjustment rings that are common to all of the container-receiving positions. These common adjustment elements or rings shift the holder sheets of each container position relative to a corresponding container-receiving-position axis. Among these embodiments are those in which the swivel axis is closer to the machine axis than it is to a container axis of the container, those in which the swivel axis and the machine axis are collinear, and those in which the first holder-sheet of the container-treatment position and a second holder-sheet of the container-treatment position are configured to be swiveled about the swivel axis, whereby the swivel axis is common to the first and second holder-sheets.

In some embodiments, there is also an adjustment ring that can be swiveled about the machine axis. In these embodiments, first and second holder-sheets of each container-receiving position are provided on the adjustment ring.

In yet other embodiments, each of the first and second holder-sheets includes an edge area. For each holder-sheet, the edge area of the holder-sheet occupies a portion of the holder-sheet that is furthest from the machine axis, extends parallel to the machine axis, and forms a contact-and-support area for containers.

Other embodiments have a toothed adjustment ring common to all container-receiving positions and a bearing element. The bearing element, which swivels about the swivel axis, includes a cog-wheel that interacts with the teeth for all of the container-receiving positions.

Also among the embodiments are those in which the conveyor is part of a container-treatment machine that has a rotor. The container-receiving positions form treatment positions on the rotor.

In some embodiments, the rotor forms an external container-guide that does not move with the rotor. The guide has a lateral surface that faces away from the machine axis and that supports containers.

Yet other embodiments include a container-treatment machine. In these embodiments, the rotor is part of the container-treatment machine. This rotor forms a plurality of at least one of container-treatment positions and container-receiving positions on a circumference thereof. Among these embodiments are those in which the container-treatment machine is a filling machine for filling containers with liquid content and those in which it is a sealing machine for sealing containers that have been filled with liquid content.

As used herein, the term “containers” includes cans, bottles, tubes, and pouches, whether made of metal, glass and/or plastic, as well as other packages, in particular those that are suitable for filling with liquid or viscous products or products in the form of powdered or granulated material.

As used herein, the terms “substantially” and “approximately” mean deviations from an exact value by ±10%, and preferably by ±5% and/or deviations that are not significant for function.

Further developments, benefits and application possibilities of the invention arise also from the following description of examples of embodiments and from the figures. In this regard, all characteristics described and/or illustrated individually or in any combination are categorically the subject of the invention, regardless of their inclusion in the claims or reference to them. The content of the claims is also an integral part of the description.

### BRIEF DESCRIPTION OF THE FIGURES

These and other features will be apparent from the following detailed description and the accompanying figures, in which

FIG. 1 shows a container-treatment machine in the form of a sealing machine for sealing containers with a seal;

FIG. 2 is a detailed representation and view from below of a container on the container-treatment machine of FIG. 1 showing two holder sheets forming between them a container pocket or bottle pocket;

FIG. 3 shows the container-treatment machine in FIG. 1 for processing containers that have a smaller diameter than the containers shown in FIGS. 1 and 2;

FIG. 4 is a detailed representation and view from below, of a container on the container-treatment machine together with two holder sheets forming between them a container pocket or bottle pocket;

FIGS. 5 and 6 show views corresponding to those in FIGS. 1 and 2 for a further embodiment of the invention; and

FIGS. 7 and 8 show views corresponding to those in FIGS. 3 and 4 for the further embodiment shown in FIGS. 5 and 6.

### DETAILED DESCRIPTION

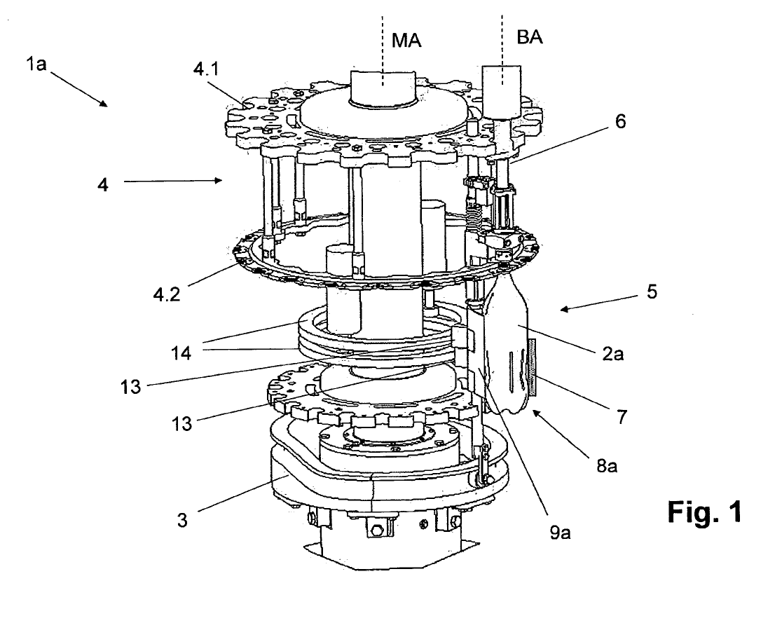

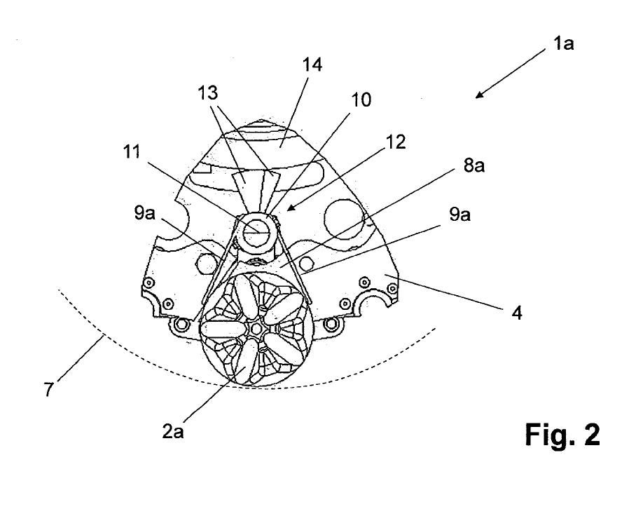

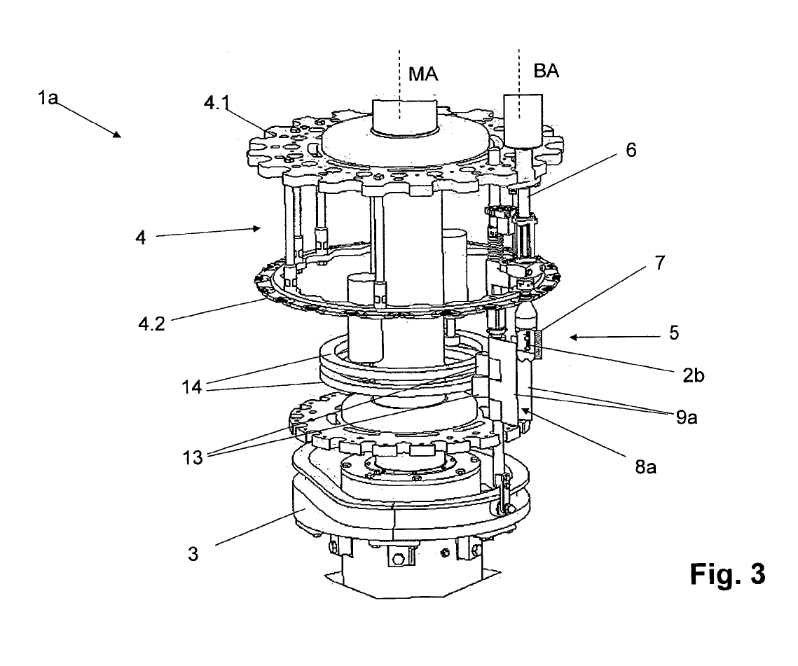

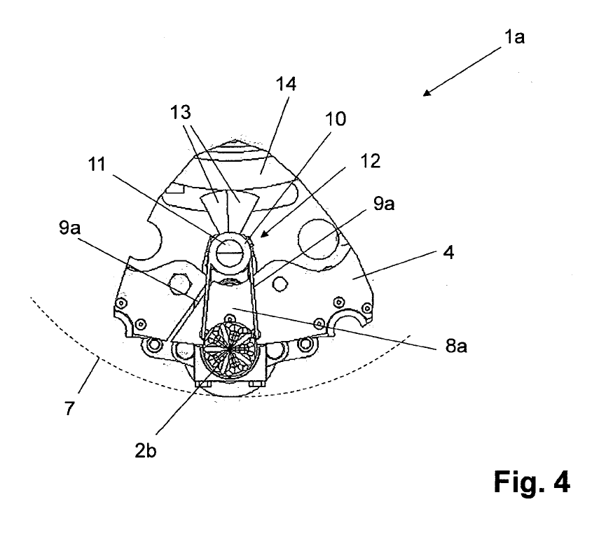

FIG. 1 shows a first container-treatment machine 1a of a rotating design. In the particular example shown, the first container-treatment machine 1a is a sealing machine for sealing containers, such as bottles 2a. The bottles can have different sizes with different bottle diameters. FIGS. 1 and 2 show relatively large bottles 2a, whereas FIGS. 3 and 4 show bottles that are considerably smaller than those shown in FIGS. 1 and 2.

The first container-treatment machine 1a includes a rotor 4 that is mounted on a machine rack. The rotor 4 rotates about a vertical machine-axis MA. The rotor 4 thus defines a conveyor of the container-treatment machine. On the circumference of the rotor 4 are container-treatment positions. In the embodiment shown, these are sealing positions 5. Only one sealing position 5 together with the bottles to be sealed 2a, 2b is illustrated in FIGS. 1-4.

The rotor 4 includes an upper rotor-element 4.1 and a lower rotor-element opposite the upper rotor-element 4.1 and separated therefrom along the machine axis MA. The lower rotor-element 4.2, which is annular, is thus below the upper rotor-element 4.1.

The upper rotor-element 4.1 holds a sealing tool 6. The lower rotor-element 4.2 forms a plurality of container holders, each of which is assigned to a sealing position 5. Each container holder suspends a bottle 2a, 2b from a flange, or neck ring, that is formed underneath the bottle's mouth.

The bottles 2a, 2b are supplied on a container inlet to the sealing positions 5 of the first container-treatment machine 1a. The sealed bottles 2a, 2b are removed from the sealing positions 5 at a container outlet. Sealing of a bottle 2a, 2b occurs within an angular area of the rotary movement of the rotor 4 between the container inlet and the container outlet. Such sealing includes, for example, screwing on a screw cap.

Referring now to FIG. 2, the first container-treatment machine 1a includes an external container-guide 7 that does not move with the rotor 4. The external container-guide 7 extends along an arc that follows the bottles' desired movement. A lateral surface of each bottle lying external relative to the machine axis slides along the container guide.

In operation, the container guide 7 ensures that each bottle 2a, 2b remains oriented with it its bottle-axis BA parallel or substantially parallel to the machine axis MA. It also ensures that the bottles 2a, 2b remain arranged coaxially or substantially coaxially with a bottle axis BA of the relevant treatment or sealing position. It does so by preventing centrifugal forces acting on the bottles 2a, 2b due to the rotary movement of the rotor 4 from tipping the bottles 2a, 2b.

The container guide 7 features a support area at which it supports the bottles 2a, 2b. At this support area, the container guide 7 is made of a material that, when paired with the material from which the bottles 2a, 2b are made, has a low friction coefficient. Examples of suitable materials from which the support area is made include plastic, stainless steel, or aluminum. Bottles 2a, 2b are typically made of glass, plastic, or PET.

Despite the foregoing effort to reduce friction between the container guide 7 and the bottles 2a, 2b, some torque is nevertheless exerted about the vertical bottle axis due to the sliding on the container guide 7.

The bottle 2a sustains a tipping force in the area under the neck ring. To avoid tipping the bottles 2a, 2b, the apparatus features two holder sheets 9a that form a container pocket 8a at each sealing position 5. The holder sheets 9a, are arranged with their surfaces on planes that are parallel to the machine axis MA and to the vertical bottle axis BA.

FIGS. 2 and 4 show one of two annular bearing elements 10 that swivel on a common bearing pin 11 about a swivel axis that is parallel to the machine axis MA. Each bearing element 10 secures one of two holder sheets 9a of each container pocket 8a. The pair of bearings forms a pair of joints, or a “double joint” 12, with the joints being offset axially relative to each other along an axial direction of the bearing pin 11. The result is a common swivel axis for both holder sheets 9a of each container pocket 8a.

The bearing pin 11 is offset radially inwards with respect to the bottle axis BA relative to the machine axis MA. At each sealing position 5, the common swivel axis formed by the double joint 12, the bottle axis BA, and the machine axis MA lie on a common vertical plane.

The two holder sheets 9a form between them a V-shaped container pocket 8a that narrows in the direction of the machine axis MA. As a result, the distance between holder sheets 9a of each sealing position 5 along a horizontal plane perpendicular to the machine axis MA decreases with decreasing distance from the machine axis MA.

As shown in FIGS. 2 and 4, the holder sheets 9a lie with vertical edge areas thereof located away from the double joint 12 and against the lateral surface of the particular bottle 2a, 2b. The contact is slight in its extent, and is substantially without pressure on the bottle.

A significant feature of the container pocket 8a is that it adapts itself to accommodate bottles having different diameters. It does so by adapting the orientation of the holder sheets 9a so that, at some points, the holder sheets 9a lie against the outer surface of the bottle. This adaptation of the holder sheet's orientation is carried out by independently swiveling the holder sheets 9a about their common swivel axis at the double-joint 12.

To facilitate this swiveling action, each bearing element 10 has a cog-wheel segment 13. The cog-wheel segment 13 has teeth that extend radially inward from the bearing element toward the machine axis MA. Each bearing element 10 is also associated with a corresponding adjusting ring 14. The adjusting ring 14 has teeth that extend radially outward from the machine axis MA. The teeth of the cog-wheel segment 13 thus engage teeth of a corresponding adjustment ring 14. As a result, moving the adjusting ring 14 has the effect of moving the bearing element 10.

As was the case with the bearing elements 10, the cog-wheel elements 13 corresponding to each bearing element 10 are also offset from each other along the direction of the machine axis MA and are coaxial with the machine axis MA. The cog-wheel segment 13 of each bearing element 10, and thus of each holder sheet 9a, interacts with an independent adjustment ring 14.

As shown in FIG. 1, the adjustment rings 14 extend all the way around the rotor 4. The adjustment rings 14 thus engage cog-wheel segments 13 associated with different container pockets 8a. By rotating the adjustment rings 14 in opposite directions, it is possible to simultaneously adapt all the container pockets 8a to be able to accommodate the diameter of the bottles 2a, 2b to be processed.

In the illustrated embodiment, at each sealing position 5, the radial distance between the swivel axis formed by the double joint 12 and the bottle axis BA is around 78% to 83% of the maximum diameter of the bottles that are being processed by the first container-treatment machine 1a. Moreover, the radial distance between the swivel axis and the bottle axis BA is around 80% to 90% of the distance of the radially external vertical edges or edge areas of the two holder sheets 9a from each other on a horizontal plane perpendicular to the machine axis MA at the largest width of the container pocket 8a.

The bottle axis BA defines a vertex of an angle between the contact areas at which the holder sheets 9a lie against a bottle. A result of the foregoing configuration, this angle remains substantially the same regardless of the bottle's diameter.

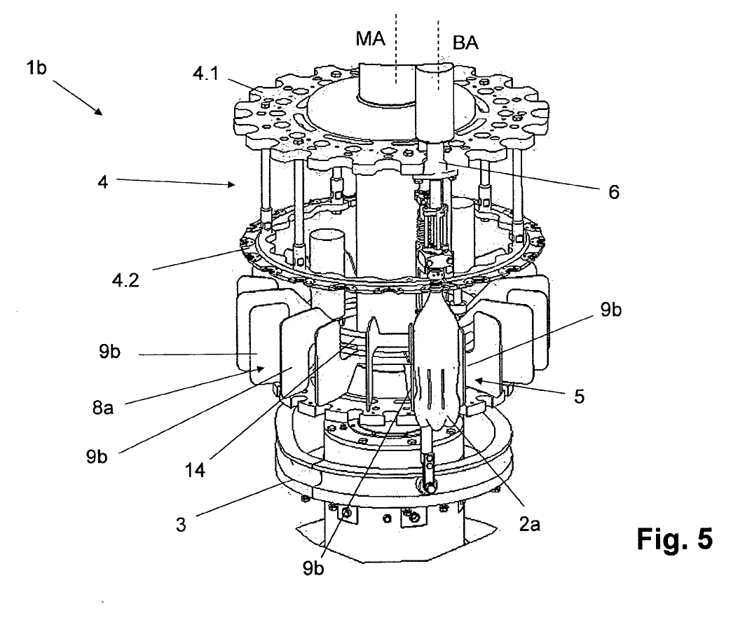

FIGS. 5-8 show a second container-treatment machine 1b that is in also formed as a sealing machine. The principal difference between the second container-treatment machine 1b and the first container-treatment machine 1a is that the two holder sheets 9b of each container pocket 8b are secured rigidly on an adjustment ring 14 radially inwards relative to the machine axis MA.

By turning the adjustment rings 14 in opposite directions about the machine axis MA and thus by swiveling the holder sheets 9b in opposite directions about the machine axis MA, it is again possible to adapt all container pockets 8b to the various diameters of bottles 2a, 2b. Adaptation is carried out by, for each container pocket 8b, adjusting the distance between the two holder sheets 9b that form that container pocket 8b.

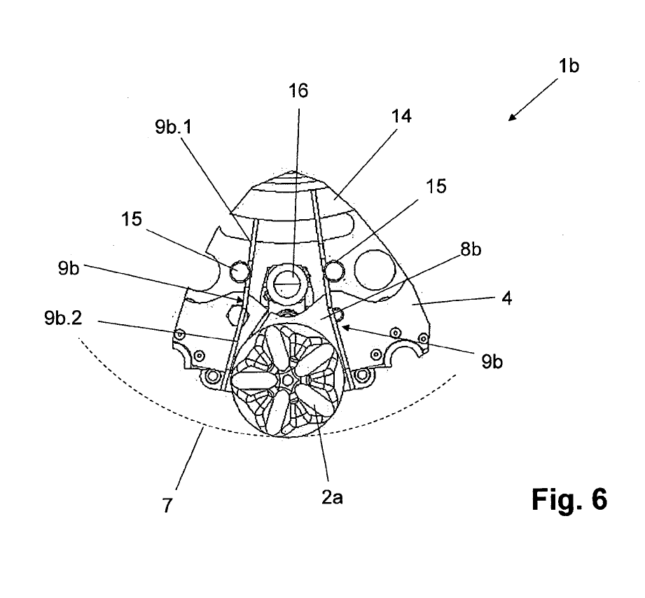

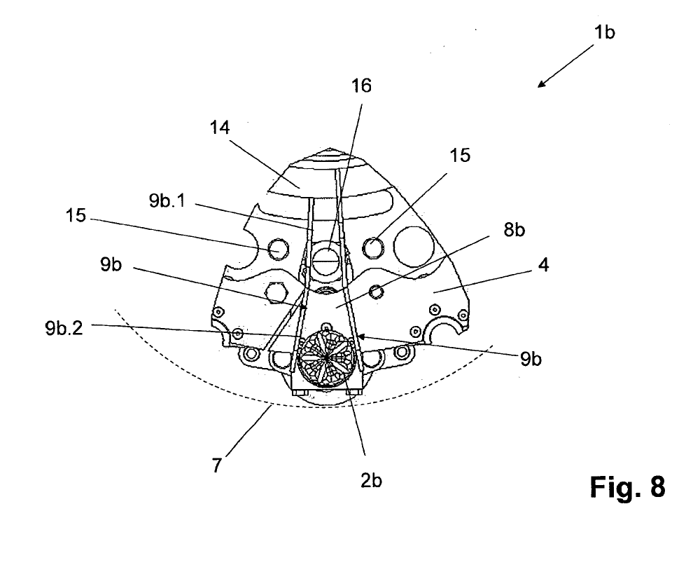

FIGS. 6 and 8 show the holder sheets 9b that are angled slightly away about at least one axis parallel to the machine axis MA. The bend that forms the angle divides each holder sheet 9b into a radially-internal section 9b.1 and a radially-external section 9b.2. The radially-internal section 9b.1 is closer to the machine axis MA than the radially-external section 9b.2. The radially-internal section 9b.1 connects to the adjustment ring 14 and the radially-external section 9b.2 connects to the radially-internal section 9b.1. As a result, the planes defined by the two radially-internal sections 9b.1 enclose a smaller angle than the planes defined by the radially-external sections 9b.2.

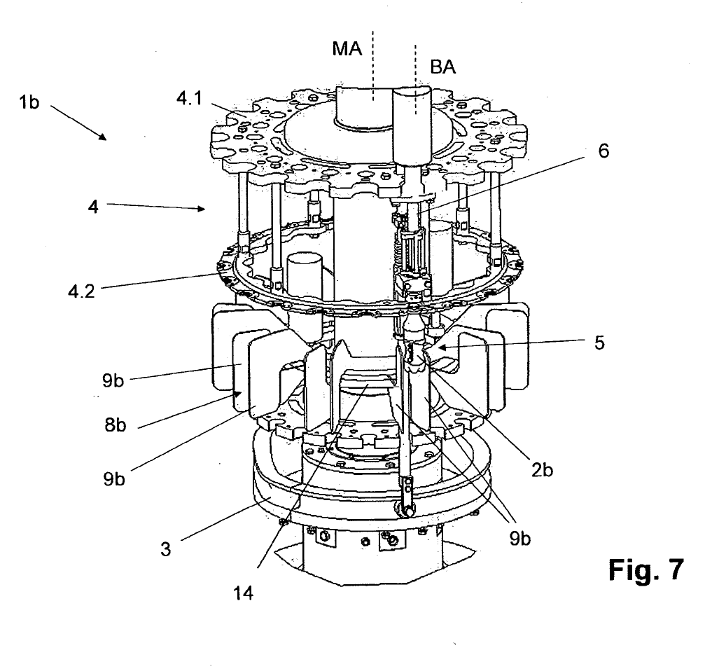

Moreover, as shown in FIG. 7, the vertical extent of the holder sheet 9b varies with radial position. In particular, the radially-internal sections 9b.1 have a vertical extent that is considerably less than that of the radially-external sections 9b.2. This is particularly useful because it is the radially-external sections 9b.2 that actually contact the bottles 2a, 2b.

The radially-external sections 9b.2 form a V-shaped container pocket 8b between them. The width of this pocket 8b width narrows as the radial coordinate decreases. To ensure that the configuration of the container pockets 8b is defined and reproducible at the two extremes of their adjustment, pins form first and second end-stops 15, 16, as shown in FIG. 8. The holder sheets 9b lie against these end-stops 15, 16.

At the largest container pocket width, the surfaces of the holder sheets 9b lie against the first end-stops 15 facing away from each other, as shown in FIG. 6. At the smallest container pocket width, the surfaces of the holder sheets 9b lie against the second end-stops 16 facing each other, as shown in FIG. 8.

Like the first container-treatment machine 1a, the second container-treatment machine 1b adapts the width of the container pockets 8b by swiveling the holder sheets 9b about an axis that is offset radially inwards with respect to the bottle axis BA. In addition, the angle about the particular bottle axis or about the bottle axis BA between the two contact areas at which the holder sheets 9b lie against the bottles is independent or substantially independent of the bottle diameter.

In both the first and second container-treatment machines 1a, 1b, the container pockets 8a, 8b are in each case formed between upright holder sheets 9a, 9b. In these upright holder sheets 9a, 9b, the surfaces of the holder sheets are coplanar with vertical planes so that over a large vertical extent there arise numerous options for a contact point with the bottles 2a, 2b. This makes it possible to process bottles of different heights without the need for a vertical adjustment of the container pockets. Also achieved is the ability to accommodate tolerances in bottle diameter and bottle height while guaranteeing a secure contact point of the bottles 2a, 2b against the holder sheets 9a, 9b.

Due to the offset of the holder sheets 9a, 9b in opposite directions, any adjustment of the container pocket width, at least the areas of the holder sheets 9a, 9b lying against the particular bottle 2a, 2b have mirror symmetry about a central plane that includes both the machine axis MA and the bottle axis BA.

The invention has been described in connection with two particular embodiments, namely the first and second container-treatment machines 1a, 1b, in which the form of container treatment is sealing. However, the principles of the invention are not limited to what is done with the containers. Thus, the container-treatment machine can also be another machine of a rotating design, such as a filling machine.

1-13. (canceled)

14. An apparatus for processing containers, said apparatus comprising a conveyor for conveying containers, wherein said conveyor comprises a rotor that is configured to be driven to rotate about a vertical machine axis, wherein said rotor comprises a plurality of container-receiving positions formed on a circumference thereof, wherein each of said first container-receiving positions comprises a container carrier, a first container-support element, a second container-support element, a first holder-sheet, and a second holder-sheet, wherein said container carrier is configured for holding a container with a container axis thereof held substantially coaxial to a container-receiving position axis of said container-receiving position, said container-receiving-position axis being oriented parallel to said machine axis, wherein said first and second container-support elements and said first and second holder-sheets are disposed underneath said container carrier, wherein said first and second holder-sheets form contact points for a lateral surface of a container, wherein said first holder-sheet is configured to be shifted radially in a first direction relative to said container axis, wherein said first holder-sheet is configured to be shifted radially in a second direction relative to said container axis, wherein said first direction is opposite said second direction, wherein radial shifting of said first holder-sheet in said first direction and radial shifting of said second holder-sheet in said second direction enable adaptation of said container-receiving position to different container diameters, wherein said first and second holder-sheets are arranged with surfaces on vertical planes that are parallel to said machine axis, wherein said first and second holder-sheets are arranged with surfaces on vertical planes that are parallel to said container-receiving-position axis, wherein said container carrier is configured to suspend a container, wherein said first and second holder-sheets form between them a container pocket for one container, and wherein said first and second holder-sheets are arranged lying opposite each other along a circumferential direction of said rotor.

15. The apparatus of claim 14, wherein said conveyor is configured to convey containers having different heights, wherein one of said heights is a greatest height, wherein said first holder-sheet extends over at least 50% of said greatest height.

16. The apparatus of claim 14, wherein said conveyor is configured to convey containers having different heights, wherein one of said heights is a greatest height, wherein said first holder-sheet extends over at least 60% of said greatest height.

17. The apparatus of claim 14, further comprising first and second adjustment elements, wherein said first and second adjustment-elements are common to all of said container-receiving positions, wherein first and second holder-sheets of each container-receiving position can be shifted relative to a container-receiving-position axis by said common adjustment elements.

18. The apparatus of claim 14, further comprising first and second adjustment rings, wherein said adjustment rings are common to all of said container-receiving positions, wherein first and second holder-sheets of each container-receiving position can be shifted relative to a container-receiving-position axis by said common adjustment rings.

19. The apparatus of claim 14, wherein at each container-receiving position, a first holder-sheet at said container-receiving position can be shifted by swiveling about a swivel axis, wherein said swivel axis is parallel to said machine axis.

20. The apparatus of claim 19, wherein said swivel axis is closer to said machine axis than it is to a container axis of said container.

21. The apparatus of claim 19, wherein said swivel axis and said machine axis are collinear.

22. The apparatus of claim 19, wherein said first holder-sheet of said container-treatment position and a second holder-sheet of said container-treatment position are configured to be swiveled about said swivel axis, whereby said swivel axis is common to said first and second holder-sheets.

23. The apparatus of claim 14, further comprising an adjustment ring that can be swiveled about said machine axis, wherein first and second holder-sheets of each container-receiving position are provided on said adjustment ring.

24. The apparatus of claim 14, wherein each of said first and second holder-sheets comprises an edge area, wherein, for each holder-sheet, said edge area of said holder-sheet occupies a portion of said holder-sheet that is furthest from said machine axis, wherein said edge area extends parallel to said machine axis, wherein said edge area forms a contact-and-support area for containers.

25. The apparatus of claim 14, further comprising an adjustment ring and a bearing element, wherein said adjustment ring comprises teeth, wherein said adjustment ring is common to all container-receiving positions, wherein said bearing element swivels about said swivel axis, wherein said bearing element comprises a cog wheel, wherein said cog wheel interacts with said teeth for all of said container-receiving positions.

26. The apparatus of claim 14, further comprising a container-treatment machine comprising a rotor, wherein said conveyor is a constituent of said container-treatment machine, and wherein said container-receiving positions form treatment positions on said rotor.

27. The apparatus of claim 14, further comprising an external container-guide, wherein said external container-guide is formed by said rotor, wherein external container-guide does not move with said rotor, wherein said external container-guide comprises a lateral surface that faces away from said machine axis, and wherein containers are supported by said lateral surface.

28. The apparatus of claim 14, further comprising a container-treatment machine, wherein said container-treatment machine comprises said rotor, wherein said rotor forms a plurality of at least one of container-treatment positions and container-receiving positions on a circumference thereof.

29. The apparatus of claim 28, wherein said container-treatment machine is a filling machine for filling containers with liquid content.

30. The apparatus of claim 28, wherein said container-treatment machine is a sealing machine for sealing containers that have been filled with liquid content.
